(19) United States
(12) Patent Application Publication
(10) Pub. No.: US 2013/0341475 A1
(43) Pub. Date: Dec. 26, 2013

(54) Stability Enhancing Attachment for Tree Stands

(71) Applicant: Michael Thompson, Virginia Beach, VA (US)

(72) Inventor: Michael Thompson, Virginia Beach, VA (US)

(21) Appl. No.: 13/532,161

(22) Filed: Jun. 25, 2012

(51) Int. Cl. F16M 13/02; B23P 11/00

(52) U.S. Cl. 248/217.4; 29/428

(57) ABSTRACT

A stability enhancing attachment (SEA) is attached to a tubular member of conventional tree stand frames. Two attachment strategies are disclosed. The SEAs are particularly useful when two tree stand frames are utilized cooperatively to support a hunter or the like in an elevated position in a tree. A first, platform-bearing lower tree stand frame supports the weight of the hunter thereupon. A second tree stand frame is also attached to the tree above the first, typically at waist height. As an occupant shifts his weight or changes position, the lower, weight-bearing tree stand frame tends to remain level and in position. However, the upper tree stand frame may shift position as the hunter moves. The SEAs of the present invention may be readily added to a standard prior art tree stand frame and used to provide stability, particularly to the upper, of a pair of tree stand frames.

### FIELD OF THE INVENTION

The invention pertains to tree stands and, more particularly, to stability enhancing attachments for use with conventional tree stands.

### BACKGROUND OF THE INVENTION

Tree stands are widely used by hunters and other outdoorsmen to provide an elevated platform in a tree upon which to stand. As used herein, the term hunter is used generally to refer to any user of a tree stand. A tree stand is typically a simple platform upon which a hunter stands or sits. An additional auxiliary support is often provided to prevent the hunter from falling. Such auxiliary supports are well known in the prior art and typically encircle the hunter at approximately their midriff. Tree stands and/or auxiliary supports of the prior art help to secure a relatively immobile hunter. However, with such prior art tree stands and/or auxiliary supports, movement of the hunter typically causes instability of the tree stand and/or auxiliary support that endangers the hunter. Certain movements by the hunter are particularly problematic with regard to destabilizing the tree stand.

One serious drawback to all known tree stands/auxiliary supports of the prior art becomes evident when the hunter leans to one side. As the tree stand is typically attached to a relatively large diameter tree, the view behind the tree to which the tree stand is affixed is thereby blocked. A noise coming from behind the tree may alert the hunter to the approach of a desired target. In response to such a noise, the hunter may attempt to peer around the tree, thereby shifting much of his or her weight to one side of the tree stand. This and other such movements by the hunter have resulted in many accidents when the tree stand/auxiliary support slips and, consequently, the hunter may fall.

Hunters who utilize tree stands or platforms above the ground to aid in hunting continue to be hampered by the unavailability of a tree stand and/or auxiliary support combination that is safe, sturdy, readily available, easy to use, relatively inexpensive, and comfortable to the user and upon which he or she can move and possibly shift weight without danger of falling. The tree stand/auxiliary support should allow free movement and minimize or eliminate the possibility of an accidental fall from the stand. Because of these discomforts, hunters may not reliably take proper aim and, accordingly, may not be able to make an accurate shot at their quarry.

Another deficiency of tree stands and auxiliary supports of the prior art relates to noise generated by movement of the hunter by the auxiliary support as well as the tree stand itself. Use of material or designs that create noise may hamper the efforts of the hunter to attract game. As will be appreciated by those skilled in the art, game, such as deer, have excellent hearing and are frightened by the slightest noise. Specifically, many of the tree stands and/or auxiliary supports of the prior art known as “climbing tree stands” utilize a variety of adjustable metal gripping elements which adjust to the diameter of the tree trunk. However, these gripping elements typically generate a great deal of mechanical noise in operation.

Further, many hunters have used devices to restrain themselves within a tree stand and have found that it is difficult and sometimes impossible to quickly release the restraining device. This lack of a quick release presents yet another safety hazard. There are times when the user needs to quickly release him or her from the device. This is hindered if the user is unable to find a release means, the release does not work as expected, or if the device does not include a quick release mechanism. In particular, safety belts which attach to the tree and to the hunter present the danger of strangulation if the hunter should fall out of the stand. In addition, many safety belt devices do not allow the freedom of movement for a user to comfortably turn and move while restrained by the devices.

In addition, climbing tree stands are typically complex and relatively difficult to assemble and use. They may also be subject to breakdown because they are constructed of many moving mechanical parts. If a connection or joint of such a tree stand should fail while in use, the stand may open, allowing the hunter to fall. Furthermore, the upper frame used in climbing tree stands such as the Amacker stand (U.S. Pat. No. 4,331,216) and similar devices must slide along the trunk of the tree as the hunter climbs the tree. Such frames do not provide sturdy, safe support of the torso because they may slide down the tree if the hunter is not sitting on the frame. In addition, once the desired elevation has been attained and the stand is in use, the prior art devices typically require the user to sit on a seat or stand on a platform with very little lateral support. In this position, the user has side support only from the tree or pole. However, the supporting frame is often so wide and is spaced so far from the tree or pole that the user would have difficulty bracing himself simultaneously from more than one direction, for example, while attempting to take aim with a rifle or shot gun.

In some prior art, the tree stand requires the hunter to attempt to aim and shoot while standing, sometimes in a direction past the supporting tree. These devices may place the hunter in an unstable and extremely dangerous position because of the recoil of the gun.

In some prior art, devices or spikes which penetrate the tree are used to attach the device to the tree. However, because of potential damage to the tree, many jurisdictions now prohibit the use of spikes. Furthermore, such devices are not easily removable from the tree.

Consequently, there is a need for a tree stand and/or auxiliary support that supports a user on a tree stand and prevents the user from inadvertently falling out of the stand while changing position and firing his weapon. The device should be sturdy, safe, lightweight, portable, easy to attach to the tree or pole, and noise-free in operation. The device must allow the hunter to assume a variety of positions safely without hindering his movements or endangering his or her safety.

### DISCUSSION OF THE RELATED ART

Attempts to provide stable tree stands and/or auxiliary supports capable of safely supporting a hunter on a tree stand when the hunter moves so as to air and fire a weapon are found in the prior art. For example, U.S. Pat. No. 4,331,216 for TREE CLIMBING STAND issued Mar. 25, 1982 to Joseph A. Amacker discloses a climbing tree stand having two elements that provide both a platform to support a hunter's feet as well as a second auxiliary element that includes a seat and a gun rack.

U.S. Pat. No. 5,276,927 for RADIOLUCENT HEAD SUPPORT, issued Jan. 11, 1994 teaches a head support seemingly unrelated to tree stands but discloses elements utilizing clamping screws to secure the structure to a patient's head.

U.S. Pat. No. 5,507,362 for TREE STAND TORSO BAR issued Apr. 16, 1996 to Wayne C. Krueger provides a torso-encircling support bar for use with a conventional tree stand or similar platform.

U.S. Pat. No. 5,971,997 INTRAOPERATIVE RECALIBRATION APPARATUS FOR STEREOTACTIC NAVIGATORS issued Oct. 26, 1999 to Barton L. Guthie et al. shows yet another apparatus seemingly unrelated to tree stands but which shows a clamped-on holder utilizing support mechanisms similar to those used to support tree stands and other similar platforms.

None of the patents and published patent applications, taken singly, or in any combination are seen to teach or suggest the novel stability enhancing attachment for tree stands of the present invention.

### SUMMARY OF THE INVENTION

In accordance with the present invention there is provided stability enhancing attachments (SEAs) for use in conjunction with a conventional, commercially available tree stand platform. The SEAs in accordance with the invention may readily be attached to a tubular member of a conventional prior art tree stand. Two attachment strategies are disclosed. The SEAs of the invention are particularly useful when two tree stand frames are utilized, cooperatively to support a hunter or the like in an elevated position in a tree or other vertical structure. A first, platform-bearing lower tree stand frame supports the weight of the hunter thereupon. A second tree stand frame is also attached to the tree or pole above the first tree stand frame, typically approximately at waist height.

As a hunter shifts his or her weight or changes position, for example to peer around the tree to which the tree stands frames are attached, the lower, weight-bearing tree stand frame tends to remain level and in position. However, the upper, waist height tree stand frame may shift position as the hunter moves resulting in a slip and possibly a fall.

The SEAs of the present invention may be readily added to a standard prior art tree stand frame and used to provide stability, particularly an upper, auxiliary support of a pair of tree stand frames. This enhanced stability is particularly useful as a hunter shifts his or her weight in the tree stand.

Typically the SEAs of the present invention include pointed screws that may be screwed into the tree or pole to prevent movement of the tree stand frame to which they are attached. However, the use of pointed screws is prohibited by state or local ordinances. Consequently, the novel SEA's also include internally threaded sleeves that may be attached over the pointed screw. The attachable sleeves have swivel feet at their distal end, the swivel foot being adapted to non-destructively contact the tree or pole.

It is, therefore, an object of the invention to provide stability enhancing attachments that may be readily attached to a conventional tree stand frame.

It is another object of the invention to provide stability enhancing attachments that have a tree-engaging screw that may be screwed into a tree to prevent vertical slippage of a v-shaped jaw member engaging the tree.

It is an additional object of the invention to provide stability enhancing attachments that attach to a hollow frame member adjacent a v-shaped jaw member.

It is a further object of the invention to provide stability enhancing attachments that utilize attachment screws that are secured in an attachment support plate.

It is a still further object of the invention to provide a stability enhancing attachment that may be retrofitted to tree stand frames.

It is yet another object of the invention to provide stability enhancing attachments that include handles providing leverage for screwing a tree-engaging screw into a tree.

It is an additional object of the invention to provide a stability enhancing attachment having selectively attachable, internally threaded sleeves that may be placed over the distal ends of the tree-engaging screws to provide swivel feet instead of a pointed end of the tree-engaging screws.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective, schematic view of a typical tree stand frame of the prior art;

FIG. 2 is a side elevational, schematic view showing two tree stands disposed one above the other on a pole or tree in a typical operating configuration;

FIG. 3 is the tree stand of FIG. 1 with a pair of stability enhancing attachments in accordance with the invention attached thereto; and

FIG. 4 is a detailed, perspective, schematic view of the tree stand stability enhancing attachment of FIG. 2 using a first method of attaching to a frame member; and

FIG. 5 is a detailed, perspective, schematic view of the tree stand stability enhancing attachment of FIG. 2 using a second method of attaching to a frame member;

FIG. 6 is perspective view of the internally-threaded sleeve for screwing over a distal end of a tree-engaging screw; and

FIG. 7 is a detailed, perspective, schematic view of the tree stand stability enhancing attachment of either FIG. 4 or FIG. 5 showing the internally threaded sleeve of FIG. 6 placed over the tree-engaging screw thereof.

### DETAILED DESCRIPTION OF THE PREFERRED EMBODIMENT

The present invention provides stability enhancing attachments for tree stands, the attachments being designed to overcome many of the stability problems of tree stands of the prior art as discussed in detail hereinabove.

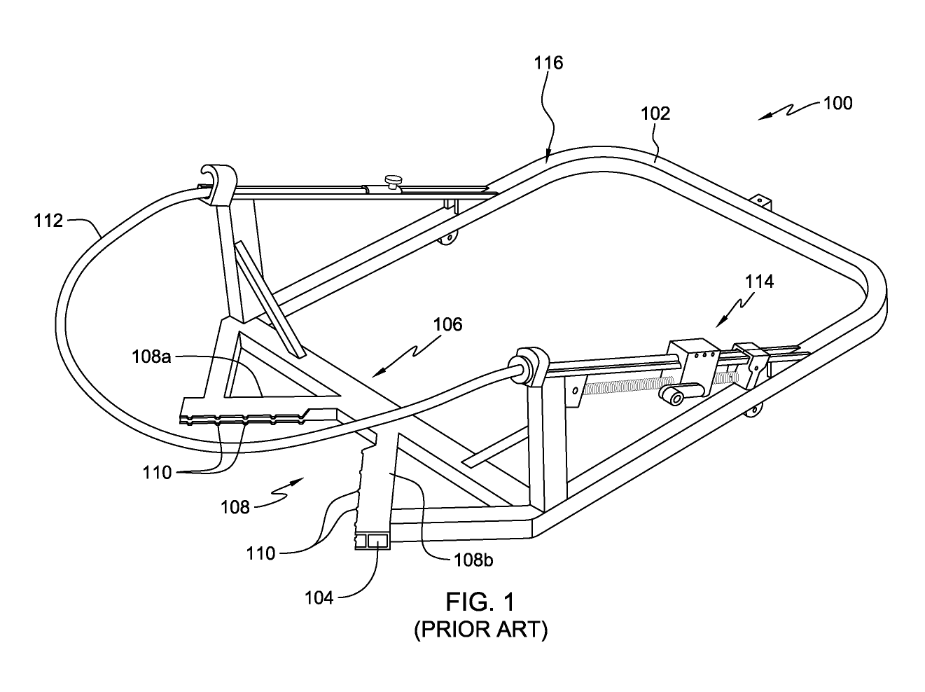

Referring first to FIG. 1, there is shown a perspective, schematic view of a tree stand of the prior art to which the novel stability enhancing attachment may be attached, generally at reference number 100.

Tree stand 100 has a substantially rectangular primary frame 102, typically formed from a tubular material 104. In the example chosen for purposes of disclosure, rectangular or square tubing 104 is used. Steel tubing 104 is typically chosen for primary frame 102 because of both its strength and weight as well the ease with which steel may be formed and welded. It will be recognized that other materials or shapes may be chosen from which to manufacture a frame for a tree stand 100.

Attached to frame 102 at a front 106 thereof is a tree/pole encircling jaw structure 108. For brevity and simplicity, the terms tree as used herein is intended to represent any vertically aligned structure (e.g., a pole) to which tree stand 100 may be attached and secured.

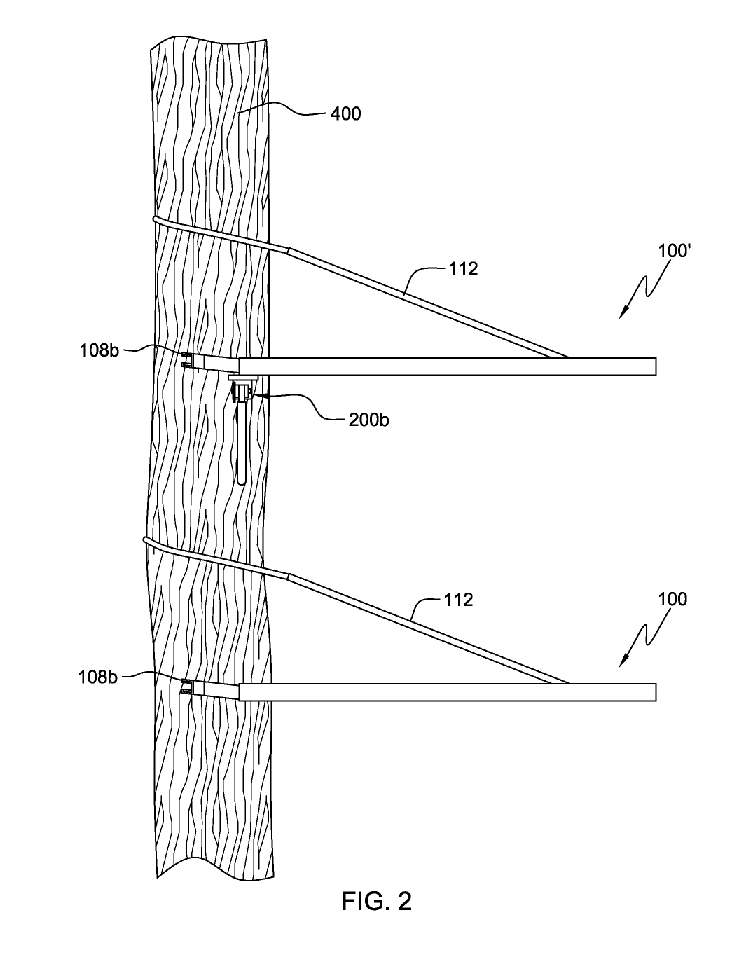

Tree-encircling jaw structure 108 consists of left jaw member 108a and right jaw member 108b. Both of right and left jaw members 108a, 108b, respectively, typically have teeth 110 disposed along outer (i.e., tree facing) edges thereof. Teeth 110 facilitate gripping a tree or pole 400 (FIG. 2) as frame 102 is pulled against a tree by a tree tensioning cable 112 in cooperation with a tensioning mechanism 114. Tensioning cable 112 encircles the tree 400.

Referring now also to FIG. 2, there is shown a side elevational, schematic view of a pair of tree stands 100, 100′ attached to a tree 400. Tree stands 100, 100′ are disposed one above the other on tree 400.

Lower tree stand frame 100 is typically equipped with a solid or semi-solid (i.e., a grate or other partially open material) platform capable of supporting the weight of a hunter thereupon, not shown. This platform is typically affixed to an upper surface 116 of frame 102, to support a hunter, not shown, or the like on an upper surface thereof. As previously stated, a tree stand such as tree stand 100 of the prior art is generally stable when there is a load thereupon. As the hunter may move on the platform, the downward pressure transferred to the tree 400 through jaw members 108a, 108b is generally sufficient to maintain tree stand 100 in position (i.e., tree stand 100 does not significantly move relative to tree 400.

Tree stand frame 100′ is typically disposed above lower tree stand frame 100 so as to surround a hunter at a midpoint of his or her torso. No platform is present so that tree stand frame 100′ encircles the hunter. While lower tree stand frame 100 tends to remain stable even as the hunter standing on its platform moves, upper tree stand frame 100′ tends to behave differently. As the hunter moves, for example, to peer around tree 400, because there is almost no downward pressure on tree stand frame 100′, one of tree encircling jaws 108a or 108b may tend to slip vertically along tree 400. This destabilizes tree stand frame 100′ and may cause the hunter to lurch or even fall.

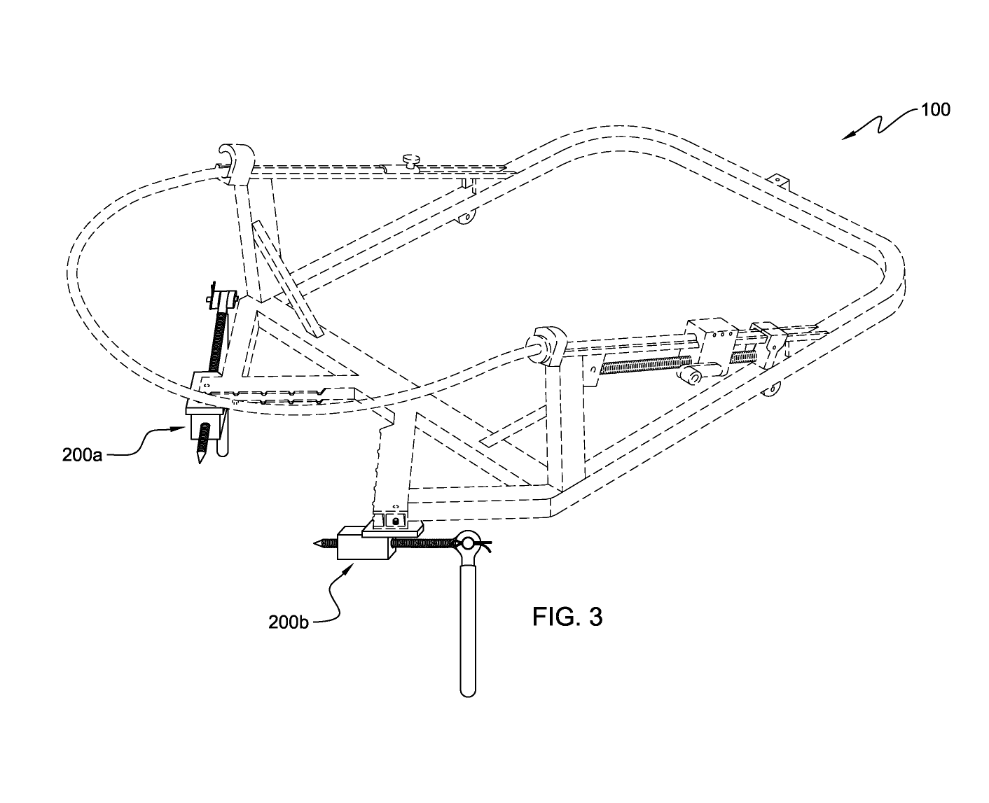

Referring now also to FIG. 3, there is shown the tree stand frame 100 of FIG. 1 with stability enhancing attachments (SEAs) 200a, 200b in accordance with the invention typically attached thereto. SEAs 200a, 200b, are typically attached at or near left and right jaw members 108a, 108b, respectively.

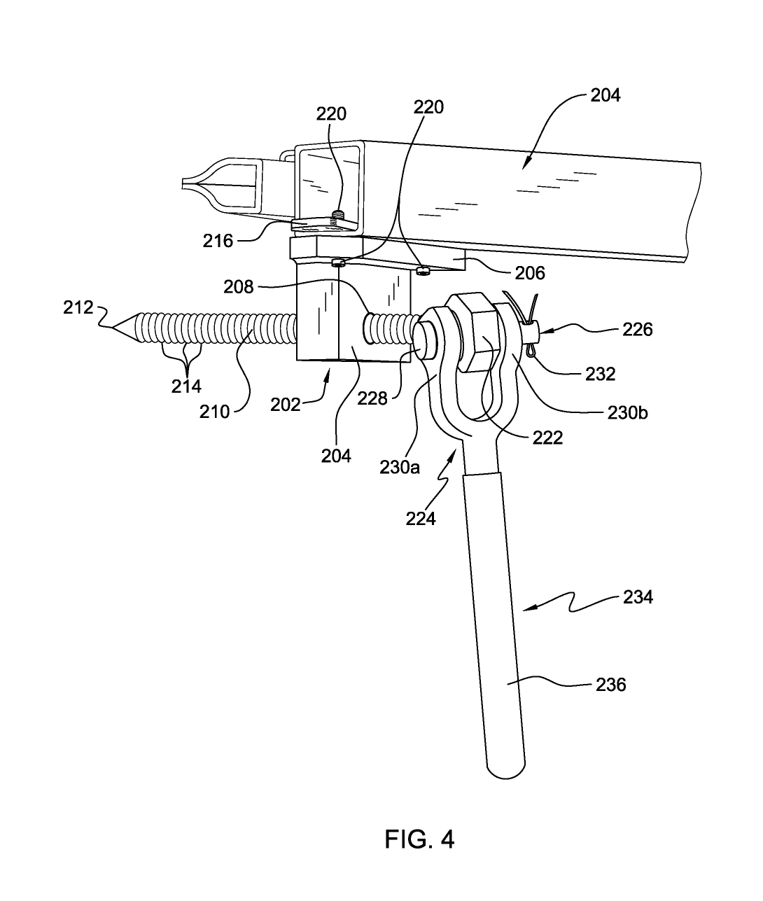

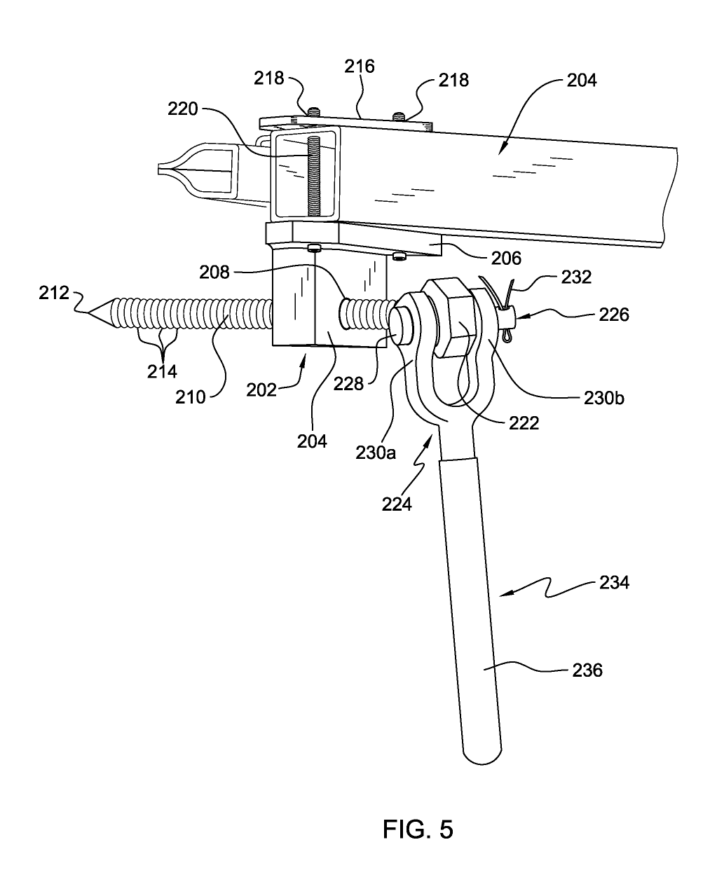

FIGS. 4 and 5 show detailed, perspective views of SEA 200b. While only one of SEAs 200a, 200b is shown in detail, SEAs 200a, 200b are mirror images of one another and are otherwise identical. FIG. 4 illustrates a first method of attachment of SEA 200b to a frame member of tree stand frame 100 while FIG. 5 shows an alternate method of fastening SEA 200b to a frame member.

Each SEA 200a, 200b has a main L-shaped support block 202 having a main body portion 204 with a mounting lip 206 disposed generally orthogonally to the main body portion 204. Main body portion has a threaded through-hole 208 sized and adapted to screwably receive the external threads 214 identified, of pole-engaging screw 210.

Pole-engaging screw 210 has a pointed distal end 212 adapted for boring into tree 400. The proximal end of pole-engaging screw 210 has an eye 222 attached thereat.

A clevis 224 is connected to eye 222 of pole-engaging screw 210 by an axle 226 having a head 228 at a proximal end and passing through the first side of the clevis frame 230a, the eye 222, and the opposite side of the clevis frame 230b. Axle 226 is retained in position by a cotter pin 232 or the like in a hole disposed adjacent a distal end of axle 226.

Clevis 224 has an elongated handle 234 extending from the clevis frame 230a, 230b. Handle 234 may have a soft covering 236 to provide a comfort grip to the handle.

In FIG. 4, SEA 200b is attached to a member of a tree stand frame tubing 104 by attachment screws 220 passing through mounting lip 206 and through a single wall of the frame tubing 104. Distal ends of mounting screws 220 are captured in threaded holes 218 in attachment plate 216 inside tubing 104.

In the alternate mounting embodiment shown in FIG. 5, attachment screws 220 pass completely through tubing 104 and are captured in threaded holes in support plate 216 that is disposed on an outer surface of tubing 104.

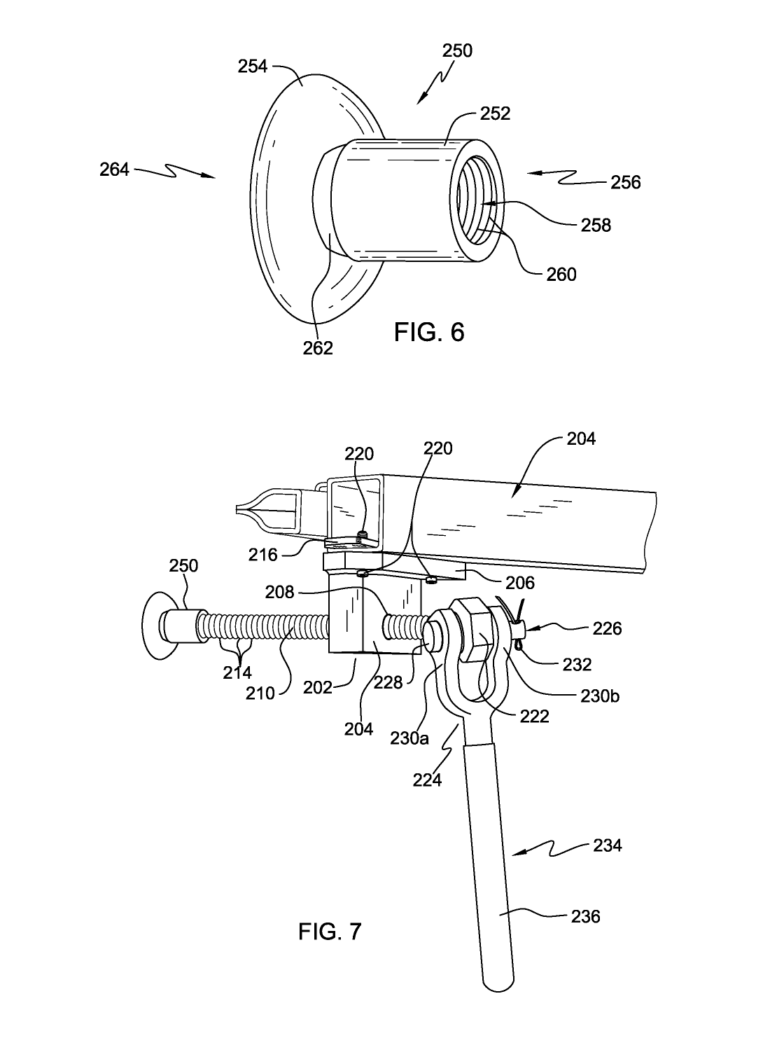

Referring now also to FIG. 6, there is shown a perspective schematic view of an internally threaded assembly 250 for placement over tree or pole-engaging screws 210. Internally threaded assembly 250 has a barrel portion 252 and a foot portion 254 swivelable with respect to said barrel portion. Barrel portion has a proximal end 256 with a central cylindrical bore 258 accessible thereat.

Internal threads 260 are disposed on an inside surface of cylindrical bore 258, internal threads 260 sized and configured to accept external threads 214 of tree-engaging screw 210.

Foot portion 254 is attached to a distal end of barrel portion 252 by a swivel joint 262 such that a outfacing surface 264 of foot portion 264 may conform to a surface of a tree or pole 400.

Referring now also to FIG. 7, there is shown a detailed, perspective, schematic view of the tree stand stability enhancing attachment of either FIG. 4 or FIG. 5 showing the internally threaded sleeve of FIG. 6 placed over the tree-engaging screw thereof.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A stability enhancing attachment to a tree stand frame, comprising:
a) a rectangular support block comprising a threaded through-hole in and orthogonal to a major surface thereof;
b) a flange disposed orthogonally to said major surface;
c) at least two mounting through-holes disposed in said flange; and
d) a tree-engaging screw having external threads along its length, said external threads being threadably received in said threaded through-hole of said rectangular support block, said tree-engaging screw having a pointed distal end and a handle disposed at a proximal end.

2. The stability enhancing attachment to a tree stand frame as recited in claim 1, further comprising:
e) an attachment support plate comprising at least two threaded holes, each adapted to receive said distal end of one of said attachment screws; and
f) at least two attachment screws having threads disposed on at least a distal portion thereof, said threads sized and configured for compatibly with said at least two threaded holes in said attachment support plate.

3. The stability enhancing attachment to a tree stand frame as recited in claim 2, wherein said attachment support plate is rectangular and is sized to fit within a tubular member of a tree stand frame upon which said stability enhancing attachment is mounted.

4. The stability enhancing attachment to a tree stand frame as recited in claim 3, wherein said at least two attachment screws have a first length for use when said attachment support plate is placed within a tubular member of a tree stand frame.

5. The stability enhancing attachment to a tree stand frame as recited in claim 2, wherein said attachment support plate is sized to fit on an outside surface of a tubular member of a tree stand frame upon which said stability enhancing attachment is mounted.

6. The stability enhancing attachment to a tree stand frame as recited in claim 3, wherein said at least two attachment screws have a second, longer length for use when said attachment support plate is placed on an outside surface of a tubular member of a tree stand frame.

7. The stability enhancing attachment to a tree stand frame as recited in claim 1, wherein said flange disposed orthogonally to said major surface of said rectangular support block is formed as in integral part thereof, thereby forming an L-shaped support block.

8. The stability enhancing attachment to a tree stand frame as recited in claim 1, wherein said handle of said tree-engaging screw further comprises a swivel joint such that at least a portion of said handle is movable with respect to a major axis of said tree-engaging screw.

9. The stability enhancing attachment to a tree stand frame as recited in claim 8, wherein said swivel joint comprises a clevis.

10. The stability enhancing attachment to a tree stand frame as recited in claim 1, wherein said handle comprises a coated exterior surface along at least a portion thereof.

11. A stability enhancing attachment for attachment to a tree stand frame, comprising:
a) an L-shaped support block comprising a body portion comprising a threaded through-hole in and orthogonal to a major surface thereof and a flange portion disposed orthogonally to said major surface of said body portion;
b) at least two mounting through-holes disposed in said flange portion;
c) a tree-engaging screw threadably received in said threaded through-hole of said L-shaped support block, said tree-engaging screw having a pointed distal end and a handle swivelably disposed at a proximal end;
d) an attachment support plate comprising at least two threaded holes each adapted to receive a distal end of an attachment screw and is sized and shaped in a way selected from the group: said attachment support plate is rectangular and is sized to fit within a tubular member of a tree stand frame to which said stability enhancing attachment is attached and said attachment support plate is sized to fit on an outside surface of a tubular member of a tree stand frame to which said stability enhancing attachment is attached; and
e) at least two attachment screws having threads disposed on a least a distal portion thereof, said threads sized and configured for compatibly with said at least two threaded holes in said attachment support plate, said at least two attachment screws have a first length when said attachment support plate is placed inside a tubing member and a second, longer length when said attachment support plate is placed outside a tubing member.

12. The stability enhancing attachment for attachment to a tree stand frame as recited in claim 11, further comprising:
f) an internally threaded sleeve adapted to receive said pointed distal end of said tree-engaging screw in a central interior internally threaded bore thereof, said internally threaded sleeve having a foot portion swivelably attached to said internally threaded sleeve at a distal end thereof.

13. A method of attaching a pair of stability enhancing attachments as recited in claim 11 to a tree stand frame, the steps comprising:
a) attaching a first of said pair of stability enhancing attachments to a tree stand frame adjacent a first V-shaped tree gripping jaw of said tree stand frame; and
b) attaching a second of said pair of stability enhancing attachments to a tree stand frame adjacent a second V-shaped tree gripping jaw of said tree stand frame.

14. A method of attaching a pair of stability enhancing attachments as recited in claim 13, wherein said attaching steps (a) and (b) both further comprise the sub-steps:
i) determining whether to place respective attachment support plates within a tubing member or external to said tubing member; and
ii selecting said attachment screws having a length appropriate for use with the placement location determined in sub-step (i).

15. A method of attaching a pair of stability enhancing attachments as recited in claim 13, the steps further comprising:
c) prior to said attaching step (a) of said first of said pair of stability enhancing attachments, aligning said first of said pair of stability enhancing attachments such that said tree engaging screw thereof is disposed orthogonal to tree-facing surface of said first V-shaped tree gripping jaw; and
d) prior to said attaching step (b) of said second of said pair of stability enhancing attachments, aligning said second of said pair of stability enhancing attachments such that said tree engaging screw thereof is disposed orthogonal to tree-facing surface of said second V-shaped tree gripping jaw.

16. The method of attaching a pair of stability enhancing attachments as recited in claim 12, the steps further comprising:
e) when said tree-engaging screw is not to be allowed to penetrate a tree, screwing said internally threaded sleeve onto said external threads of a distal end of said tree-engaging screw

17. A method of attaching a pair of stability enhancing attachments as recited in claim 12, the steps further comprising:
c) after mounting said tree stand to said tree, using a respective one of said handles to turn an associated one of said tree-engaging screws so as to move said point at said distal end thereof toward a tree upon which said tree stand frame is attached until said tree-engaging screw penetrates said tree.
